(19) United States
(12) Patent Application Publication
(10) Pub. No.: US 2025/0333560 A1
(43) Pub. Date: Oct. 30, 2025

(54) ISOCYANATE CURING WITH BOUND WATER

(71) Applicant: SIKA TECHNOLOGY AG, Baar (CH)

(72) Inventors: Burkhard WALTHER, Trostberg (DE); Christian BRUCHERTSEIFER, Trostberg (DE); Olaf JANSSEN, Düsseldorf (DE); Anika WERNING, Taunusstein (DE)

(73) Assignee: SIKA TECHNOLOGY AG, Baar (CH)

(21) Appl. No.: 18/695,617

(22) PCT Filed: Feb. 2, 2023
(86) PCT No.: PCT/EP2023/052599

§ 371 Date: Mar. 26, 2024

(30) Foreign Application Priority Data
Feb. 2, 2022 (EP) 22154780.5

(51) Int. Cl. C08G 18/30; C08G 18/12; C08G 18/24; C08G 18/48; C08G 18/50; C08K 3/22

(52) U.S. Cl. CPC C08G 18/302; C08G 18/12; C08G 18/246; C08G 18/4854; C08G 18/5024; C08K 3/22; C08K 2003/2206

(57) ABSTRACT

A multi-component composition includes an isocyanate-reactive compound, an isocyanate compound, a source of chemically bound water, optionally a catalyst, and optionally a CO₂ scavenger. A process for preparing a polyurea polymer by curing that multi-component composition with the source of chemically bound water. The polyurea polymer obtainable by that process and also the use of a specific source of chemically bound water for curing that multi-component composition.

The present invention relates to a multi-component composition comprising an isocyanate-reactive compound, an isocyanate compound, a source of chemically bound water, optionally a catalyst, and optionally a CO₂ scavenger. Moreover, the present invention relates to a process for preparing a polyurea polymer by curing that multi-component composition with the source of chemically bound water. Finally, the present invention relates to the polyurea polymer obtainable by that process and also to the use of a specific source of chemically bound water for curing that multi-component composition.

Polyurea is a type of elastomer that is the reaction product of an isocyanate component and a polyfunctional amine component or water. The isocyanate component can be aromatic or aliphatic. It can be a monomer, an oligomer, a prepolymer or a polymer. Polyurea polymers are particularly suitable as adhesives, sealants, coatings, potting compounds and self-leveling compounds.

Polyurea formation by reaction of isocyanates with water has been used for a long time but suffers from insufficient pot life time and levelling issues. Current formulations show a strong tendency towards bubble formation, especially with higher thicknesses, due to the reaction between isocyanate and water. With other words, the reaction between isocyanate and water is much too fast for sufficient degassing or CO₂ capture by a basic additive, the so-called “CO₂ scavenger”. A strong need thus existed for slowing down that reaction and thus extending pot life times.

In US 2015/0259465 A1 (abstract), this problem has been partially solved by a two-component polyurethane composition containing a polyol, a polyisocyanate, a blocked amine (i.e. an oxazolidino group or an aldimino group-see claim 1) and a bismuth (III)- or zirconium (IV)-catalyst. That composition was easy to process, cured quickly and without bubbles, and had unexpectedly high strength when in the cured state. Said composition could additionally contain water or a water-generating substance (claim 14), e.g. inorganic compounds, which contained water coordinatively bound or as water of crystallization [0109].

However, EP 2706073 A1 does not relate to polyurea polymers but only to polyurethane polymers. Moreover, the concept of a blocked amines in combination with low amounts of water has disadvantages. A blocked aldimine, for instance, reacts with some of the added water to result in a primary amine and an aldehyde. A smelling aldehyde with high VOC content is then released. Moreover, the equilibrium of a blocked amine/water/polyisocyanete system is strongly on the side of the NCO-reaction products, and the reaction is not strongly retarded. The present invention, in contrast, does not employ blocked amines.

US 2017/355862 A1 discloses (claim 1) a fire-protection composition, comprising an ingredient A, which contains an isocyanate compound, an ingredient B, which contains a reactive component capable of reacting with an isocyanate compound and which is selected from the group consisting of compounds with at least two amino groups, wherein the amino groups, independently of one another, are primary and/or secondary amino groups, and an ingredient C, which contains an ablatively acting fire-protection additive. Moreover, claim 12 mentions as component C, inter alia, aluminum hydroxide, ettringite and hydrous zeolites. However, only calcium carbonate is used in the experiments of US 2017/355862 A1.

Paragraph of US 2017/355862 A1 mentions that Ingredient C is divided in a way so that neither a reaction or mutual interference of the compounds contained in the composition with one another nor a reaction of these compounds with the compounds of the other ingredients can take place. This may have worked with calcium carbonate but not with aluminum hydroxide, ettringite and hydrous zeolites. These water-containing compounds would have reacted with the isocyanate component and consequently would have lost their ablatively acting fire-protection capabilities. Aluminum hydroxide, ettringite and hydrous zeolites are therefore not enabled in US 2017/355862 A1. On the other hand, US 2017/355862 A1 is silent on the utility of these compounds for isocyanate curing.

It was the object of the present invention to essentially avoid the disadvantages of the prior art. In particular, the speed of the polyurea formation or, in other words, the polyisocyanate/water reaction should be slowed down, thus allowing for an increased pot life time. By retarding the polyisocyanate/water reaction, foaming should become more controllable. However, both, foamed and unfoamed reaction products were desirable. The physical properties of the reaction products should be satisfactory.

These objects have been achieved with the technical features of the independent claims. The dependent claims relate to preferred embodiments.

It was surprisingly found that chemically bound water retards the polyurea formation reaction, thus increasing pot life times, and bubble formation becomes more controllable. This reaction may be performed with or without a CO₂ scavenger as a further key ingredient. The latter will transform the CO₂ formed into e.g. CaCO₃.

In case of the present invention, a primary reaction between polyols and/or polyfunctional amines with NCO groups takes place. A secondary reaction occurs by reaction of NCO groups with chemically bound water via amine groups with simultaneous CO₂ formation. This second reaction is delayed due to the masking of the water and thus leading to an overall increased pot life of the system. Water is bound chemically as crystal water such as in Ettringite. The CO₂ scavenger can for instance be Ca(OH)₂, but it may also be the crystal water-containing compound, such as the Ettringite itself.

According to a first aspect, the present invention provides a multi-component composition comprising the following components:

(A) an isocyanate-reactive compound; (B) an isocyanate compound selected from the group consisting of polyisocyanates and NCO-terminated prepolymers; and (C) a source of chemically bound water; and (D) optionally a catalyst; and (E) optionally a CO₂ scavenger. The source of chemically bound water acts as an isocyanate curing agent in the multi-component composition.

### General Definitions

As used herein, the term “multi-component” refers to a composition comprising two or more components, each of which may also be a mixture of several compounds. Part of the multi-components can be blended together if needed, and the multi-components may also be several independent packages that can be mixed on the spot for applications.

As used herein, the term “prepolymer” refers to a monomer or system of monomers that have been reacted to an intermediate molecular mass state. This material is capable of further polycondensation by reactive groups to a fully cured high molecular weight state. It is usually a reaction product of a polyisocyanate with a polyol or a polyfunctional amine, which reaction product is NCO-terminated.

As used herein, the terms “additive” or “additives” refer to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, surfactants, wetting agents, defoaming agents, dispersants, flow or slip aids, biocides, and stabilizers.

As used herein, the term “alkyl”, either on its own or else in combination with further terms, is understood as meaning a radical of a saturated aliphatic hydrocarbon group and may be branched or unbranched, for example methyl, ethyl, propyl, butyl, isobutyl, pentyl, hexyl, heptyl, octyl, nonyl, decyl, undecyl or dodecyl, or an isomer thereof.

As used herein, the term “alkenyl”, either on its own or else in combination with further terms, is understood as meaning a straight-chain or branched radical which has at least one double bond, for example vinyl, allyl, propenyl, butenyl, butadienyl, pentenyl, pentadienyl, hexenyl, or hexadienyl, or an isomer thereof.

As used herein, the term “cycloalkyl”, either on its own or else in combination with further terms, is understood as meaning a fused or non-fused, saturated, monocyclic or polycyclic hydrocarbon ring, for example cyclopropyl, cyclobutyl, cyclopentyl, cyclohexyl, cycloheptyl, or cyclooctyl, or an isomer thereof.

As used herein, the term “alkoxy”, either on its own or else in combination with further terms, is understood as meaning linear or branched, saturated, group having a formula-O-alkyl, in which the term “alkyl” is as defined above, for example methoxy, ethoxy, propoxy, butoxy, pentoxy, or hexoxy, or an isomer thereof.

As used herein, the term “aryl”, either on its own or else in combination with further terms, is understood to include fused or non-fused aryl, such as phenyl or naphthyl, wherein phenyl is optionally substituted by 1 to 5 groups, and naphthyl is optionally substituted by 1 to 7 groups. The term “aryloxy” means-O-aryl. The term “arylalkoxy” means-O-alkyl-aryl and alkylaryloxy means-O-aryl-alkyl. The term “aryl” is meant to include also heteroaryl.

As used herein, the term “hetero-” is understood as meaning a saturated or unsaturated radical which is interrupted by at least one heteroatom selected from the group consisting of oxygen (O), nitrogen (N), and sulphur (S).

The term “substituted” means that one or more hydrogens on the designated atom is replaced with a selection from the indicated group, provided that the designated atom's normal valency under the existing circumstances is not exceeded, and that the substitution results in a stable compound. Combinations of substituents and/or variables are permissible only if such combinations result in stable compounds. Suitable substituents are meant to include, but are not limited to, C₁-C₆-alkyl-, cyano-, amino-, halogen-, hydroxyl-, or oxo (resulting in aldehyde or keto) groups.

The term “optionally substituted” means optional substitution with the specified groups, radicals or moieties. Unless stated otherwise, optionally substituted radicals may be mono- or poly-substituted, where the substituents in the case of poly-substituted may be the same or different from each other.

Unless otherwise identified, all percentages (“%”) are “percent by weight”. “Parts” are “parts by weight”. All percentages of a composition shall add up to 100%.

The meaning of the term “comprising” is to be interpreted as encompassing all the specifically mentioned features as well as optional unspecified ones, whereas the term “consisting of” only includes those features as specified. The term “comprising” thus includes the narrower term “consisting of”.

The radical definitions given above in general terms or within areas of preference apply to the end products and correspondingly to the starting materials and intermediates. These radical definitions can be combined with one another as desired, i.e. including combinations between the general definition and/or the respective ranges of preference and/or the embodiments.

All the embodiments and the preferred embodiments disclosed herein can be combined as desired, which are also regarded as being covered within the scope of the present invention.

Unless otherwise identified, the temperature refers to room temperature and the pressure refers to ambient pressure.

### Organic Isocyanate-Reactive Component (A)

It is possible to use, as organic isocyanate-reactive compound (A), any of the known compounds used for the production of polyurethane, selected from the group consisting of polyols and poly-functional amines.

It is preferred to use polyols having at least two hydroxyl groups, for example those with functionality from 2 to 8. By way of example, it is possible to use compounds selected from the group hydroxyl-ended polyethers (polyether polyols), polyesters (polyester polyols) or polycarbonates (polycarbonate polyols), and mixtures thereof.

Polyether polyols are by way of example produced from epoxides, for example propylene oxide and/or ethylene oxide, or from tetrahydrofuran with starter compounds exhibiting hydrogen-activity, for example aliphatic alcohols, phenols, amines, carboxylic acids, water, or compounds based on natural substances, for example sucrose, sorbitol or mannitol, with the use of a catalyst. As polyester polyols, it is preferred to use a dihydric or trihydric polyether having an equivalent weight of from about 100 to about 1500.

Polyester polyols are by way of example produced from aliphatic or aromatic dicarboxylic acids and polyhydric alcohols, polythioether polyols, polyesteramides, hydroxylated polyacetals, and/or hydroxylated aliphatic polycarbonates, preferably in the presence of an esterification catalyst.

Polycarbonate polyols include those prepared by the reaction of diols, such as 1,3-propanediol, 1,4-butanediol, diethylene glycol, triethylene glycol or thiodiglycol with phosgene or diarylcarbonate, such as diphenyl carbonate. These polymeric polyols may have a number average molecular weight of about 400 to about 15000.

Suitable polyols include, but are not limited to (poly) ethylene glycol, (poly) 1,2-und 1,3-propylene glycol, (poly) 2-methyl-1,3-propane diol, (poly) 1,2-, 1,3-, 1,4- and 2,3-butane diol, (poly) 1,6-hexane diol, (poly) 1,8-octane diol, (poly) neopentyl glycol, (poly) cyclohexane dimethanol, (poly) cyclohexane-1,4-diol, (poly) 1,4-bishydroxymethyl cyclohexane, (poly) 1,5-pentane diol, (poly) 3-methyl-1,5-pentane diol, (poly) 1,12-dodecane diol, diethylene glycol, triethylene glycol, tetraethylene glycol, pentaethylene glycol, dipropylene glycol, dibutylene glycol; glycerol, sorbitol, trimethylolpropane, 1,2,4-butane triol, 1,2,6-hexane triol, pentaerythritol, polyester polyols from aliphatic and/or aromatic sources such as polycaprolactones, adipates, terephthalate esters, polycarbonates, polyether polyols including polyethylene glycol, polypropylene glycol, polytetramethylene glycol (all of which are possible starting materials for prepolymers having an-NCO functionality of ≥2). Also suitable are polyhydroxylated natural oils and their derivatives, such as modified castor oil. In addition, mixtures of said compounds may be used.

Low molecular polyols can also be added for use as chain extenders or crosslinkers. Low molecular polyols refer to monomeric polyols with molecular weight of less than 400 and at least two hydroxyl groups. Suitable polyols with low molecular weight are in particular diols, triols or both, in each case having molecular weights of less than 350, preferably from 60 to 300 and in particular from 60 to 250. It is possible to use, for example, aliphatic, cycloaliphatic and/or aromatic diols having from 2 to 14, preferably from 2 to 10, carbon atoms, e.g. ethylene glycol, 1,2-, 1,3-propanediol, 1,2-, 1,3-pentanediol, 1,10-decanediol, 1,2-, 1,3-, 1,4-dihydroxycyclohexane, diethylene glycol and triethylene glycol, dipropylene glycol and tripropylene glycol, 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules. Among the polyols listed above, castor oil is particularly mentioned and preferred.

A polyfunctional amine is an amine with a functionality of ≥2. The amine component may be either linear or branched. The skeleton of the amine component may contain aliphatic, aromatic, aliphatic-aromatic, cycloaliphatic and heterocyclic structures. The amine function itself is aliphatic, i.e. the nitrogen is not part of an aromatic ring. Preferred polyfunctional amines are amino functionalized polyalkylene glycols, such as, for example, the Jeffamines® from Huntsman Corp., e.g. the Jeffamines D-230, D-400, D-2000, D-4000, T-403, T-3000, T-5000, ED-600, ED-2003, or amines of the general formula H₂N—(CH₂CH₂—NH)ₒ—CH₂CH₂—NH₂, where o=1 to 10, such as, for example, diethylenetriamine. Polymers which are selected from polyamines, dendritic polyamines, polyimines (such as, for example, the polyethyleneimines of the Lupasol® type from BASF SE), polyamides, polyaminoamides, polyvinylamines or mixtures thereof are possible as the polyfunctional amine component. Of further interest are isophorone diamine and polyester diamines (such as poly(1,4-butanediol) bis(4-aminobenzoate).

It should be noted that the multi-component composition of the present invention does not contain blocked amines (such as oxazolidino groups or aldimino groups).

### Isocyanate Component (B)

As component (B), any polyisocyanate and/or NCO-terminated prepolymer that is conventionally used for preparing polyurethane resin can be used herein. Suitable polyisocyanates can be all of the aliphatic, cycloaliphatic, and aromatic polyisocyanates, including, but not limited to, tetramethylene diisocyanate, hexamethylene diisocyanate (HDI), dodecamethylene diisocyanate, isophorone diisocyanate (IPDI), 4,4′-dicyclohexylmethane diisocyanate (H12MDI), 1,4-cyclohexane diisocyanate (CHDI), 4,4′-diisocyanatodicyclohexyl-2,2-propane, p-phenylene diisocyanate, 2,4- and 2,6-toluene diisocyanate (TDI) or mixtures thereof, tolidine diisocyanate, 2,2′-, 2,4′- and 4,4′-diphenylmethane diisocyanate (MDI) or oligomers or mixtures thereof, 1,2-naphthylene diisocyanate, xylylene diisocyanate, tetramethylxylene diisocyanate (TMXDI), and mixtures thereof.

It is preferred to use toluene diisocyanate (TDI), diphenylmethane diisocyanate (MDI), oligomeric MDI, hexamethylene diisocyanate (HDI), trimeric HDI and/or isophorone diisocyanate (IPDI). The above-mentioned isocyanates can also be modified, for example to form uretedione, isocyanurate, carbodiimide, allophanate, and urethane groups.

“Oligomeric MDI” is described by the following formula where n=1 to 8.

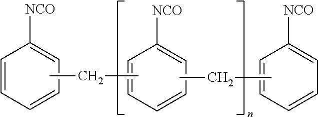

“Trimeric HDI” is described by the following formula.

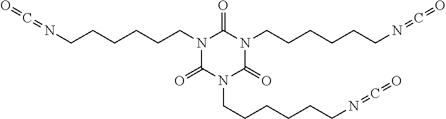 [SMILES: O=C=NCCCCCCn1c(=O)n(CCCCCCN=C=O)c(=O)n(CCCCCCN=C=O)c1=O]

Isocyanates used herein can also be isocyanate prepolymers containing NCO end groups. These isocyanate prepolymers are obtainable by reacting polyisocyanates as described above, for example at temperatures of from 20 to 120° C., with isocyanate-reactive compounds such as polyols or polyfunctional amines to give the prepolymer. These prepolymers may have an isocyanate content of 2 to 25% and a number average molecular weight of about 500 to about 30,000.

Polyols and polyfunctional amines that can be used for the production of isocyanate prepolymers are known to the person skilled in the art. It is preferable here that polyols and polyfunctional amines used for the production of isocyanate prepolymers are those included in the description relating to organic isocyanate-reactive compound (A).

### Chemically Bound Water (C)

The multi-component composition comprises a source of chemically bound water to take part in the urea-forming reaction. As opposed to physically bound water, the term “chemically bound water” means water that is bound in crystalline form, for example in ettringite, calcium silicate hydrate (CSH), aluminum hydroxide, zeolites, and the like. These materials may also be used in combination with each other and/or in combination with CO₂ scavengers. The source of chemically bound water according to the invention can be selected from the group consisting of ettringite, calcium silicate hydrate, aluminum hydroxide, zeolites, and mixtures thereof, preferably selected from the group consisting of ettringite, calcium silicate hydrate, aluminum hydroxide, and mixtures thereof.

If the multi-component composition is held available in separate components. The chemically bound water and the CO₂ scavenger, if present, are usually stored together with the organic isocyanate-reactive compound, i.e. within the (A) component.

The chemically bound water should exhibit a sufficiently low vapor pressure within its carrier in order to enable a sufficiently long pot life and a sufficiently low foaming of the reaction mixture. It is obvious that the source of chemically bound water must be selected in accordance with the reactivity of the isocyanate compound.

### Catalyst (D)

The catalyst is an optional component. As a catalyst, it is possible to use all compounds which accelerate the polyurethane reaction and/or urea reaction. Such compounds are known in the art. Preferably, catalyst (D) comprises an alkaline catalyst such as amine-based catalysts and catalysts based on organic metal compounds.

As amine-based catalysts, it is possible to use, for example, bis(2-dimethylaminoethyl) ether, N,N,N,N, N-pentamethyldiethylenetriamine, N,N,N-triethylaminoethoxyethanol, N,N,N′,N′-Tetra-kis(2-hydroxyethyl)ethylenediamine, dimethylcyclohexylamine, dimethylbenzylamine, triethyl-amine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene, diazabicyclononene, 2,2′-dimorpholinodiethylether, N,N,N′-trimethyl-N′-hydroxyethyl-bisaminoethylether, N,N,N′-trimethylaminoethyl-ethanolamine, N,N,N′,N′-Tetrakis(2-hydroxypropyl)ethylenediamine, N,N-bis(3-dimethylaminopropyl)-N-iso-propanolamine, and N-(3-dimethylaminopropyl)-N,N-diisopropanolamine, or mixtures thereof.

As catalysts based on organic metal compounds, it is possible to use, for example, organic tin compounds such as tin(II) salts of organic carboxylic acids, e.g. tin(II) acetate, tin(II) octanoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, e.g. bismuth(III) neodecanoate, bismuth 2-ethylhexanoate and bismuth octanoate, or alkali metal salts of carboxylic acids, e.g. potassium acetate or potassium formate.

### CO₂Scavenger (E)

The CO₂ scavenger is an optional component. If foamed products are desired, no CO₂ scavengers should be included. On the other hand, if unfoamed products are desired, it can be of advantage to include a CO₂ scavenger in the multi-component composition. Useful CO₂ scavengers are those known in the art, and in particular MgO, CaO, Ca(OH)₂, and cement, such as Portland cement. Most preferred are CaO and Ca(OH)₂. As mentioned above, the CO₂ scavenger in two-component systems is usually stored together with the organic iso-cyanate-reactive compound, i.e. within the (A) component. It has been shown in the experiments hereinbelow that ettringite is capable of acting as a CO₂ scavenger on its own.

As mentioned earlier, the isocyanate-reactive compound of the invention may be selected from polyols, and in particular from polyether polyols, polyester polyols, polycarbonate polyols, and mixtures thereof. However, the isocyanate-reactive compound of the invention may also be selected from polyfunctional amines.

The isocyanate compound of the invention may be selected from the group consisting of toluene diisocyanate (TDI), diphenylmethane diisocyanate (MDI), oligomeric MDI, hexamethylene diisocyanate (HDI), trimeric HDI, isophorone diisocyanate (IPDI), and mixtures of two or more of these polyisocyanates. It may also be selected from prepolymers of these isocyanates.

The source of chemically bound water of the invention may be selected from ettringite, calcium silicate hydrate, aluminum hydroxide, zeolites, and mixtures thereof.

The catalyst of the invention may be selected from the group consisting of amine-based catalysts and catalysts based on organic metal compounds, in particular dibutyltin dilaurate.

The CO₂ scavenger of the invention may be selected from CaO and Ca(OH)₂, and mixtures thereof.

The multi-component composition of the invention may be formulated as one mixture comprising all components and immediately beginning to react. However, it is also possible that the components (A) and (C) and optionally (D) and (E) are provided in one mixture (component) and the isocyanate compound (B) is held available separately as another component.

According to a second aspect, the present invention provides a process for preparing a polyurea polymer by curing a multi-component composition with a source of chemically bound water, comprising mixing (A) an isocyanate-reactive compound, (B) an isocyanate compound selected from the group consisting of polyisocyanates and NCO-terminated prepolymers, and (C) a source of chemically bound water, and (D) optionally a catalyst, and (E) optionally a CO₂ scavenger, and allowing the mixture to cure. Curing will yield a polyurea polymer, obtainable by this process.

According to a third aspect, the present invention provides the use of a source of chemically bound water selected from ettringite, calcium silicate hydrate, aluminum hydroxide, zeolites, and mixtures thereof, in a multi-component composition for curing that composition, wherein the multi-component composition comprises the following components:
(A) an isocyanate-reactive compound; and
(B) an isocyanate compound selected from the group consisting of polyisocyanates and NCO-terminated prepolymers; and
(D) optionally a catalyst; and
(E) optionally a CO₂ scavenger.

The present invention will now be illustrated in more detail by means of the following examples.

### EXAMPLES

### General Procedure

The materials that have been used are listed in Table 1 hereinbelow. The constituents of the A components were mixed. The viscosities and densities of these A components were measured. Then the isocyanate compounds were added to the A component. This preparation was mixed in a speed mixer (Hauschild DAC 600.1 FVZ) for 1 min. @ 2000 rpm. The resulting freshly prepared reactive mixtures were poured on polypropylene sheets, allowed to dry at 23° C./50% relative humidity for 7 days, peeled off and measured.

Viscosities were measured with a Modular Compact Rheometer MCR 302 (Anton Paar) according to DIN EN ISO 3219. Densities of the preparations were measured according to DIN EN ISO 2811-1. Shore A/D hardness: DIN 53505. Elongation@Break/Tensile Strength: DIN EN ISO 527-1.

### Example 1

Several multi-component compositions comprising a polyether diamine as the isocyanate-reactive compound (i.e. poly(propylene glycol) bis(2-aminopropyl ether)) and an MDI prepolymer were formulated with different sources of water. In two batches, CO₂ scavengers were present. The individual formulations and the results thereof are listed in Table 2 hereinbelow.

This was a very reactive system. It was not possible to reach sufficient pot life times with 5% of water (although bound to zeolite, i.e. batches #4 and #5), while chemically bound water such as in ettringite, Al(OH)₃, and CSH increased pot life times to up to ≥2 hours. Even Ca(OH)₂ could not suppress the foaming of batch #5. Sufficient amounts of ettringite (batch #2) worked better than lime paste in combination with ettringite (batch #1) in suppressing foaming.

### Example 2

Several multi-component compositions comprising a polyester diamine as the isocyanate-reactive compound (i.e. poly(1,4-butanediol) bis(4-aminobenzoate)) and an MDI prepolymer were formulated with different sources of water. In two batches, CO₂ scavengers were present. The individual formulations and the results thereof are listed in Table 3 hereinbelow.

This was a very reactive system. It was not possible to reach sufficient pot life times with 5% of water (although bound to zeolite, i.e. batches #11 and #12), while chemically bound water such as in ettringite, Al(OH)₃, and CSH increased pot life times to 2 hours and more. Ettringite alone (#10) worked better than ettringite in combination with lime paste (#9) in suppressing foaming.

### Example 3

Example 2 was repeated with a carbodiimide-modified MDI as the isocyanate component. The individual formulations and the results thereof are listed in Table 4 hereinbelow.

The results were essentially the same as in Example 2. Best results were obtained with ettringite as a source of chemically bound water (pot life times of up to 5 h in batch #17 and up to 3 h in batch #18—ettringite alone resulted in less foaming than ettringite in combination with lime paste). Zeolite-bound water was also feasible in this experiment.

### Example 4

Example 1 was repeated with polytetramethylene glycol (Poly THF) as the isocyanate-reactive compound and trimeric HDI as the isocyanate component. The individual formulations and the results are listed in Table 5 hereinbelow.

This was basically a polyurethane system with only a few polyurea functions. All batches (except Al(OH)₃ at small A/B mixing ratios—batch #24) resulted in good pot life times. However, almost all batches resulted in foaming.

TABLE 1

| Component | Name | Function | Chemistry | Supplier | CAS No. |
|---|---|---|---|---|---|
| PEthDA | Baxxodur EC 303 | NCO-Reactive Compound | Polyether Diamine | BASF SE | 9046-10-0 |
| TIBP | Triisobutyl Phosphate | Diluent | Organic Phosphate Ester | Lanxess | 126-71-6 |
| PEstDA | Versalink P-1000 | NCO-Reactive Compound | Polyester Diamine | Evonik | 54667-43-5 |
| DisperByk | Disperbyk 110 | Dispersive Agent | Acidic Copolymer Composition | Byk/Altana | |
| PolyTHF | PolyTHF 650 (S) | NCO-Reactive Compound | Polytetramethylene Glycol | BASF SE | 25190-06-1 |
| DIBTDL | Cosmos 19 | Catalyst | Dibutyl-Tin Dilaurate | Evonik | 77-58-7 |
| DIPN | Rütasolv DI | Diluent | Diisopropyl Naphthalene | Rain Carbon | 38640-62-9 |
| KemFoamEx | KemFoamEx 6426 | Defoamer | Hydrocarbons/Cyclohexanone | Kemira | |
| Ettringite | Casul H1i | Chemically Bound Water | Synthetic Ettringite | Remondis | 12004-14-7 |
| Ca(OH)₂ | Magnesia 7245 | CO₂ Scavenger | Calcium Hydroxide | Magnesia GmbH | 1305-62-0 |
| Al(OH)₃ | Apyral 24 | Chemically Bound Water | Aluminum Hydroxide | Nabaltec | 21645-51-2 |
| Zeolite | Sylosiv A3 | Chemically Bound Water | Aluminum Silicate | Grace | 1318-02-1 |
| CSH # 1 | Circosil | Chemically Bound Water | Tobermorite (88%) | Cirkel | 1319-31-9 |
| CSH # 2 | Circolit | Chemically Bound Water | Xonotlit | Cirkel | 1344-95-2 |
| H₂O | Water | | | | 7732-18-5 |
| Lime Paste | Lime Paste | CO₂ Scavenger | Ca(OH)₂ Dispersion ¹⁾ | MBSD ²⁾ | |
| MDI Prepoly. | MDI Prepolymer | Isocyanate Compound | MDI Prepolymer ³⁾ | MBSD ²⁾ | |
| MMDI | Suprasec 2029 | Isocyanate Compound | Carbodiimide-Modified MDI | Huntsman | |
| HDI Trimer | Desmodur N 3600 | Isocyanate Compound | HDI Trimer | Covestro | |

¹⁾ Consisting of 38.17% DIPN, 0.76% dispersive agent (Trisize 68), and 61.07% Ca(OH)₂
²⁾ Semi fabricate of Master Builders Deutschland GmbH
³⁾ Prepolymer of 50.99% MDI (Lupranat MI, BASF SE), 49% polypropylene glycol (Lupranol 1000, BASF SE) and 0.01% diglycol-bis-chloroformiate

TABLE 2

| Component A | # 1 | # 2 | # 3 | # 4 | # 5 | # 6 | # 7 |
|---|---|---|---|---|---|---|---|
| PEthDA | 22.22 | 22.50 | 22.50 | 37.50 | 28.50 | 22.50 | 22.50 |
| TIBP | 22.22 | 22.50 | 22.50 | 37.50 | 28.50 | 22.50 | 22.50 |
| DIPN | | 8.50 | 8.50 | 8.50 | 8.50 | 8.50 | 8.50 |
| KemFoamEx | | 1.50 | 1.50 | 1.50 | 1.50 | 1.50 | 1.50 |
| Ettringite | 30.56 | 45.00 | | | | | |
| Ca(OH)₂ | | | | | 18.00 | | |
| Al(OH)₃ | | | 45.00 | | | | |
| Zeolite | | | | 10.00 | 10.00 | | |
| H₂O | | | | 5.00 | 5.00 | 1.00 | |
| CSH # 1 | | | | | | 44.00 | |
| CSH # 2 | | | | | | | 45.00 |
| Ca Silicate | | | | | | | |
| Lime Paste | 25.00 | | | | | | |
| Viscosity @ 23° C. [mPa s] | 370 | 300 | 110 | 60 | 1800 | 2700 | 2590 |
| Density @ 20° C. [g/ml] | 1.22 | 1.16 | 1.32 | 1.03 | 1.15 | 1.30 | 1.35 |

Component B MDI Prepolymer ³⁾ Ratio A/B: a) 100/30, b) 100/50, c) 100/100

| | | | | | | | |
|---|---|---|---|---|---|---|---|
| Pot Life | ≥2 h | ≥2 h | ≥2 h | 45 min | 30-35 min | ≥2 h | ≥2 h |
| Shore A Hardness @ 7 d | Foamed | Solid | Solid | Foamed | Foamed | a) Foamed | Solid |
| | | a) 79, | a) 61, | | | b, c) Solid | a) 68, |
| | | b) 83, | b) 83, | | | b) 86, | b) 83, |
| | | c) 86 | c) 91 | | | c) 92 | |
| Elongation @ Break | Foamed | a) 80%, | a) 77% | Foamed | Foamed | a) Foamed | a) 97% |
| | | b) 109% | b) 249% | | | b) 45% | b) 152% |
| | | c) 185% | c) 245% | | | c) 47% | c) 154% |
| Tensile Strength | Foamed | a) 2.8 MPa | a) 2.3 MPa | Foamed | Foamed | a) Foamed | a) 4.0 MPa |
| | | b) 3.3 MPa | b) 7.4 MPa | | | b) 5.5 MPa | b) 8.1 MPa |
| | | c) 5.3 MPa | c) 9.1 MPa | | | c) 6.1 MPa | c) 9.4 MPa |

TABLE 3

| Component A | # 8 | # 9 | # 10 | # 11 | # 12 | # 13 | # 14 |
|---|---|---|---|---|---|---|---|
| PEstDA | 40.50 | 58.50 | 58.50 | 68.50 | 46.50 | 57.50 | 58.50 |
| DisperByk | 0.50 | 0.50 | 0.50 | 0.50 | 0.50 | 0.50 | 0.50 |
| DIPN | 10.00 | 14.50 | 14.50 | 14.50 | 18.50 | 14.50 | 14.50 |
| KemFoamEx | 1.50 | 1.50 | 1.50 | 1.50 | 1.50 | 1.50 | 1.50 |
| Ettringite | 25.00 | 25.00 | | | | | |
| Ca(OH)₂ | | | | | 18.00 | | |
| Al(OH)₃ | | | 25.00 | | | | |
| Zeolite | | | | 10.00 | 10.00 | | |
| Water | | | | 5.00 | 5.00 | 1.00 | |
| CSH # 1 | | | | | | 25.00 | |
| CSH # 2 | | | | | | | 25.00 |
| Ca Silicate | | | | | | | |
| Lime Paste | 22.50 | | | | | | |
| Viscosity @ 23° C. [mPa s] | 4600 | 5330 | 3180 | 2600 | 4700 | 6780 | 8600 |
| Density @ 20° C. [g/ml] | | 1.13 | 1.18 | 1.09 | 1.20 | 1.18 | 1.18 |

Component B MDI Prepolymer ³⁾ Ratio A/B: a) 100/30, b) 100/50, c) 100/100

| | | | | | | | |
|---|---|---|---|---|---|---|---|
| Pot Life | a, b) 2 h | a) 2 h, | a, b) 2 h | a, b) 1 h | a, b, c) 15 min | a, b) 2 h | a) 2 h, |
| | c) 5 h | b) 3 h | c) 5 h | c) 1.15 h | | c) 5 h | b) 3 h |
| | | c) 5 h | | | | | c) 5 h |
| Shore A Hardness @ 7 d | a) 82, | a) 70, | a) 78, | Foamed | Foamed | Foamed | a) 67, |
| | b) 76 | b) 70 | b) 76 | | | | b) 74 |
| | c) 81 | c) 67 | c) 79 Foamed | | | | c) 74 |
| Elongation @ Break [%] | a) Foamed | a) 36, | a) 170, | Foamed | Foamed | Foamed | a) 27, |
| | b) 110, | b) 42 | b) 490 | | | | b) 378 |
| | c) 450 | c) 170 | c) 280 | | | | c) Foamed |
| Tensile Strength [MPa] | a) Foamed | a, b) 1.3 | a) 2.6, | Foamed | Foamed | Foamed | a) 1.7, |
| | b) 3.7, | c) 6.5 | b) 9.6 | | | | b) 5.4 |
| | c) 2.9 | | c) 13.1 | | | | c) Foamed |

TABLE 4

| Component A | # 15 | # 16 | # 17 | # 18 | # 19 | # 20 | # 21 |
|---|---|---|---|---|---|---|---|
| PEstDA | 40.50 | 58.50 | 58.50 | 68.50 | 46.50 | 57.50 | 58.50 |
| DisperByk | 0.50 | 0.50 | 0.50 | 0.50 | 0.50 | 0.50 | 0.50 |
| DIPN | 10.00 | 14.50 | 14.50 | 14.50 | 18.50 | 14.50 | 14.50 |
| KemFoamEx | 1.50 | 1.50 | 1.50 | 1.50 | 1.50 | 1.50 | 1.50 |
| Ettringite | 25.00 | 25.00 | | | | | |
| Ca(OH)₂ | | | | | 18.00 | | |
| Al(OH)₃ | | | 25.00 | | | | |
| Zeolite | | | | 10.00 | 10.00 | | |
| Water | | | | 5.00 | 5.00 | 1.00 | |
| CSH # 1 | | | | | | 25.00 | |
| CSH # 2 | | | | | | | 25.00 |
| Lime Paste | 22.50 | | | | | | |
| Viscosity @ 23° C. [mPa s] | 3348 | 4810 | 2827 | 2819 | 4700 | 5763 | 8408 |
| Density @ 20° C. [g/ml] | 1.19 | 1.14 | 1.18 | 1.07 | 1.20 | 1.19 | 1.17 |

Component B MMDI (Carbodiimide-Modified MDI) Ratio A/B: a) 100/30, b) 100/50, c) 100/100

| | | | | | | | |
|---|---|---|---|---|---|---|---|
| Pot life | a) 2 h | a) 45 min | a) 30 min | a) 45 min | a) 15 min | a) 15 min | a) 1 h |
| | b) 3 h | b) 90 min | b) 30 min | b) 90 min | b) 15 min | b) 15 min | b) 30 min |
| | c) 5 h | c) 3 h | c) 60 min | c) 3 h min | c) 30 min | c) 45 min | c) 2 h |
| Shore D hardness @ 7 d | a) 52, | a) 52, | a) 52, | a) 46, | Foamed | a) 20, | a) 51, |
| | b) 54 | b) 51 | b) 56 | b) 53 | | b) 27 | b) 49 |
| | c) 53 | c) 56 | c) 58 | c) 23 | | c) 48 | c) 61 |
| Elongation @ Break [%] | Foamed | a) 210 | a) 230 | a) 270 | Foamed | Foamed | Foamed |
| | | b) 90 | b) 120 | b) 150 | | | |
| | | c) Foamed | c) Foamed | c) Foamed | | | |
| Tensile Strength [MPa] | Foamed | a) 10 | a) 17.8 | a) 19.4 | Foamed | Foamed | Foamed |
| | | b) 10 | b) 15.3 | b) 15.8 | | | |
| | | c) Foamed | c) Foamed | c) Foamed | | | |

TABLE 5

| Component A | # 22 | # 23 | # 24 | # 25 | # 26 | # 27 |
|---|---|---|---|---|---|---|
| PolyTHF | 40.00 | 57.95 | 57.95 | 82.95 | 64.95 | 56.95 |
| DIBTDL | 0.05 | 0.05 | 0.05 | 0.05 | 0.05 | 0.05 |
| DisperByk | 0.50 | 0.50 | 0.50 | 0.50 | 0.50 | 0.50 |
| KemFoamEx | 1.50 | 1.50 | 1.50 | 1.50 | 1.50 | 1.50 |
| Ettringite | 40.00 | 40.00 | | | | |
| Ca(OH)₂ | | | | | 18.00 | |
| Al(OH)₃ | | | 40.00 | | | |
| Zeolite | | | | 10.00 | 10.00 | |
| Water | | | | 5.00 | 5.00 | 1.00 |
| CSH # 1 | | | | | | 40.00 |
| Lime paste | 17.95 | | | | | |
| Viscosity @ 23° C. [mPa s] | 5740 | 3790 | 985 | 492 | 2800 | 6820 |
| Density @ 20° C. [g/ml] | 1.16 | 1.2 | 1.31 | 1.05 | 1.2 | 1.3 |

Component B HDI Trimer Ratio A/B: a) 100/30, b) 100/50, c) 100/100

| | | | | | | |
|---|---|---|---|---|---|---|
| Pot Life | ≥2 h | a) 2 h | a) 25 min | a) 1 h | a) 1.10 h | ≥2 h |
| | | b) 3 h | b) 1 h | b) 3 h | b) 1.10 h | |
| | | c) 5 h | c) 5 h | c) 5 h | c) 5 h | |
| Shore A Hardness @ 7 d | a) 65, | a) 66, | a) 77, | Foamed | Foamed | a) 59, |
| | b) 60 | b) 76 | b) 80 | | | b) 81 |
| | c) Foamed | c) 70 | c) 53 | | | c) (Shore D) 35 |
| Elongation @ Break [%] | Foamed | Foamed | a) 30, | Foamed | Foamed | Foamed |
| | | | b) 20 | | | |
| | | | c) Foamed | | | |
| Tensile Strength [MPa] | Foamed | Foamed | a) 2.0, | Foamed | Foamed | Foamed |
| | | | b) 2.8 | | | |
| | | | c) Foamed | | | |

1. A multi-component composition comprising the following components:
(A) an isocyanate-reactive compound;
(B) an isocyanate compound selected from the group consisting of polyisocyanates and NCO-terminated prepolymers; and
(C) a source of chemically bound water; and
(D) optionally a catalyst; and
(E) optionally a CO₂ scavenger.

2. The multi-component composition according to claim 1, wherein the isocyanate-reactive compound (A) is selected polyols.

3. The multi-component composition according to claim 1, wherein the isocyanate-reactive compound (A) is selected from polyfunctional amines.

4. The multi-component composition according to claim 1, wherein the isocyanate compound (B) is selected from the group consisting of toluene diisocyanate (TDI), diphenylmethane diisocyanate (MDI), oligomeric MDI, hexamethylene diisocyanate (HDI), trimeric HDI, isophorone diisocyanate (IPDI), and mixtures of two or more of these polyisocyanates.

5. The multi-component composition according to claim 1, wherein the isocyanate compound (B) is selected from prepolymers of the group consisting of toluene diisocyanate (TDI), diphenylmethane diisocyanate (MDI), oligomeric MDI, hexamethylene diisocyanate (HDI), trimeric HDI, isophorone diisocyanate (IPDI), and mixtures of two or more of these polyisocyanate prepolymers.

6. The multi-component composition according to claim 1, wherein the source of chemically bound water (C) is selected from ettringite, calcium silicate hydrate, aluminum hydroxide, zeolites, and mixtures thereof.

7. The multi-component composition according to claim 1, wherein the catalyst (D) is selected from the group consisting of amine-based catalysts and catalysts based on organic metal compounds.

8. The multi-component composition according to claim 1, wherein the CO₂ scavenger (E) is selected from CaO and Ca(OH)₂, and mixtures thereof.

9. The multi-component composition according to claim 1, wherein the components (A) and (C) and optionally (D) and (E) are provided in one component and the isocyanate compound (B) is held available separately in another component.

10. A process for preparing a polyurea polymer by curing a multi-component composition with a source of chemically bound water, comprising mixing
(A) an isocyanate-reactive compound,
(B) an isocyanate compound selected from the group consisting of polyisocyanates and NCO-terminated prepolymers, and
(C) a source of chemically bound water, and
(D) optionally a catalyst, and
(E) optionally a CO₂ scavenger, and
allowing the mixture to cure.

11. A polyurea polymer, obtainable by the process according to claim 10.

12. A method comprising:
curing a multi-component composition with a source of chemically bound water selected from ettringite, calcium silicate hydrate, aluminum hydroxide, zeolites, and mixtures thereof, wherein the multi-component composition comprises the following components:
(A) an isocyanate-reactive compound;
(B) an isocyanate compound selected from the group consisting of polyisocyanates and NCO-terminated prepolymers; and
(D) optionally a catalyst; and
(E) optionally a CO₂ scavenger.

13. The method according to claim 12, wherein the source of chemically bound water is selected from ettringite, calcium silicate hydrate, aluminum hydroxide, and mixtures thereof.
